(19) United States
(12) Patent Application Publication
(10) Pub. No.: US 2009/0087743 A1
(43) Pub. Date: Apr. 2, 2009

(54) ELECTRODE, METHOD OF PREPARING THE SAME, AND LITHIUM BATTERY INCLUDING THE ELECTRODE

(75) Inventors: Gue-sung KIM, Suwon-si (KR); Yong-nam Ham, Suwon-si (KR); Young-min Choi, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/138,860

(22) Filed: Jun. 13, 2008

(30) Foreign Application Priority Data
Oct. 2, 2007 (KR) 2007-99398

(51) Int. Cl. H01M 4/66; H01M 4/58

(52) U.S. Cl. 429/217; 429/231.8

(57) ABSTRACT

An electrode includes a current collector and an active material layer on top of the current collector, wherein the active material layer includes an active material and a binder, and a complex of a first conductive agent and a binding agent is formed on a surface of the active material; a method of manufacturing the same, and a lithium battery including the electrode.

### CROSS-REFERENCE TO RELATED APPLICATIONS

This application claims the benefit of Korean Application No. 2007-99398, filed Oct. 2, 2007, in the Korean Intellectual Property Office, the disclosure of which is incorporated herein by reference.

### BACKGROUND OF THE INVENTION

1. Field of the Invention

Aspects of the present invention relate to an electrode, a method of preparing the same, and a lithium battery including the electrode. More particularly, aspects of the present invention relate to an electrode including an active material layer having an active material and a complex of a conductive agent and a binding agent on a surface of the active material, a method of preparing the same, and a lithium battery including the electrode. The electrode has high charge/discharge rate properties, so that a high-quality lithium battery can be obtained.

2. Description of the Related Art

Recently, as various small portable electronic devices such as portable computers, portable communication devices, or camcorders are required to have smaller sizes and lighter weights, there is an increasing demand that batteries are smaller, lighter, thinner, and have a higher capacity. Accordingly, research relating to rechargeable secondary batteries, such as, for example, Ni-MH (nickel metal hydride) batteries, closed nickel-cadmium batteries, lithium metal batteries, lithium ion batteries, lithium polymer batteries, and sulfur batteries, has been actively conducted.

Among the currently used active materials for batteries, lithium has a large electric capacity per unit mass and a large electronegativity, and thus can be used to provide a high voltage battery. However, since the stability of a lithium metal is low, research is actively being carried out regarding batteries using materials in which intercalation and deintercalation of a lithium metal and lithium ions are possible.

A representative example of such batteries is a lithium secondary battery, which produces electrical energy by oxidation/reduction when lithium ions intercalate/deintercalate in the cathode and anode. The lithium secondary battery uses a material allowing reversible intercalation/deintercalation of lithium ions as an active material for the cathode and/or anode, and is prepared by charging an organic electrolyte or a polymer electrolyte between the cathode and the anode. Such a cathode active material for the lithium secondary battery may be LiCoO₂, which has superior lifespan and discharge consistency.

In order to improve the performance of various electrode active materials, research on adding a conductive agent to an active material is taking place. For example, in Korean Patent Laid-Open Publication No. 2005-0038254, an electrode for lithium batteries which includes a cathode active material, a binder, a conductive agent, and an electroconductive linear fiber (such as carbon nanotube) is disclosed.

### SUMMARY OF THE INVENTION

According to an aspect of the present invention, there is provided an electrode which includes a current collector and an active material layer on top of the current collector, wherein the active material layer includes an active material and a binder, a surface of the active material containing complex of a first conductive agent and a binding agent.

According to another aspect of the present invention, there is provided a method of preparing an electrode, including: preparing a first mixture including an active material, a first conductive agent, and a solvent; adding a binding agent to the first mixture to obtain a second mixture and stirring the second mixture; preparing a third mixture in which the first conductive agent and the binding agent form a complex on a surface of the active material, from the second mixture; preparing an active material layer forming composition by adding a binder to the third mixture; and forming an active material layer on top of a current collector using the active material layer forming composition.

According to yet another aspect of the present invention, there is provided a lithium battery including a cathode, an anode, and an electrolyte, wherein at least one of the cathode and the anode is prepared according to the previously-described method.

According to another aspect of the present invention, there is provided an active material composition comprising an active material in the form of particles having an average particle size of 1-20 μm and a complex of a first conductive material and a binding agent, wherein the complex of the first conductive material and the binding agent binds to the active material.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic diagram illustrating a cross-section of an active material layer in an electrode according to an embodiment of the present invention;

FIG. 2 is a flowchart of a method of preparing an electrode, according to an embodiment of the present invention;

FIGS. 3A and 3B are SEM (scanning electron microscopy) images of an active material layer in a conventional cathode plate, wherein the photographs are taken at different magnifications; and

FIGS. 4A, 4B, and 4C are SEM images of an active material layer in a cathode plate prepared according to an embodiment of the present invention, wherein the photographs are taken at different magnifications.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

An electrode according to aspects of the present invention includes a current collector and an active material layer on top of the current collector. The active material layer includes an active material and a binder, wherein a complex of a first conductive agent and a binding agent is present on a surface of the active material. The complex of the first conductive agent and the binding agent contributes to improving the high rate charge/discharge characteristics of the electrode. The active material layer may further selectively include a second conductive agent in between particles of the active material and/or between the active material and the current collector.

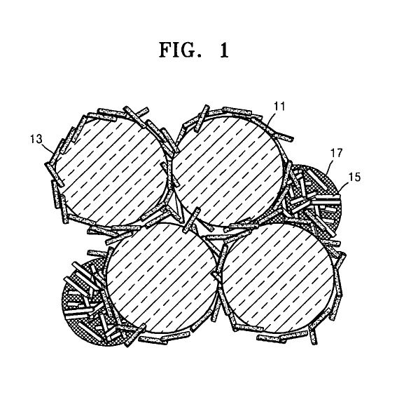

FIG. 1 is a schematic diagram illustrating a cross-section of an active material layer in an electrode according to an embodiment of the present invention. Referring to FIG. 1, according to an embodiment of the present invention, a complex 13 of a first conductive agent and a binding agent is present on a surface of an active material 11 of the active material layer, and a second conductive agent 15 and a binder 17 exists between particles of the active material 11.

The active material 11 may be a cathode active material or an anode active material, and can be selected without specific limitations as long as the material can undergo an electrochemical redox reaction. Such materials that are capable of electrochemical redox include metals such as lithium, tin, or titanium, a lithium-containing alloy, a sulfur-based compound, a metal hydride (MH), a material that can reversibly form a compound with lithium, or a material wherein lithium ions can intercalate/deintercalate (a lithium intercalation compound).

As non-limiting examples, the lithium-containing alloy may be lithium-aluminum alloy, lithium-tin alloy, or lithium-magnesium alloy. The sulfur-based compound, which is an active material for a cathode of a lithium-sulfur battery, may include a sulfur element, Li₂Sn(n≧1), Li₂Sn(n≧1) dissolved in a catholyte, organic sulfur compound, and a carbon-sulfur polymer ((C₂Sₓ)ₙ: x=2.5 to 50, n≧2). A material that can reversibly form a compound with lithium may be silicon or tin dioxide (SnO₂).

Representative non-limiting examples of the lithium-containing compound include: LiₓMn_{1-y}M_{y}A₂, LiₓMn_{1-y}M_{y}O_{2-z}A_{z}, LiₓMn₂O_{4-z}A_{z}, LiₓMn_{2-y}M_{y}A₄, LiₓCo_{1-y}M_{y}A₂, LiₓCoO_{2-z}A_{z}, LiₓNi_{1-y}M_{y}A₂, LiₓNiO_{2-z}A_{z}, LiₓNi_{1-y}Co_{y}O_{2-z}A_{z}, LiₓNi_{1-y-z}Co_{y}M_{z}A_{α}, LiₓNi_{1-y-z}Co_{y}M_{z}O_{2-α}A_{α}, LiₓNi_{1-y-z}Mn_{y}M_{z}A_{α}, and LiₓNi_{1-y-z}Mn_{y}M_{z}O_{2-α}A_{α}, wherein x, y, z, and a are 0.95≦x≦1.1, 0≦y≦0.5, 0≦z≦0.5, 0<α≦2 respectively, and M is an element selected from the group consisting of Al, Ni, Co, Mn, Cr, Fe, Mg, Sr, V, and a rare earth element, and A is an element selected from the group consisting of O, F, S, and P.

Alternatively, the active material 11 may be an anode active material, and may include at least one metal or alloy thereof selected from the group consisting of Si, Sn, Al, Ge, Pb, Zn, Ag, and Au.

The active material 11 may be in the form of particles having an average particle size of 0.1-50 μm, or, more specifically, 1-20 μm.

The complex 13 of the first conductive agent and the binding agent is present on the surface of the active material 11. The term “complex of a first conductive agent and a binding agent” refers to a complex structure of a first conductive agent and a binding agent that are physically and/or chemically bonded together. The term “first conductive agent” refers to a conductive agent making up the “f complex of a first conductive agent and a binding agent”, and is used to distinguish this conductive agent from another conductive agent that may be added together with a binder when preparing the active material layer forming composition (which is referred to in the present specification as a “second conductive agent”).

The complex 13 of the first conductive agent and the binding agent may be present only on a part of the surface of the active material 11. Alternatively, the complex 13 of the first conductive agent and the binding agent may cover entire surface of the active material 11 in the form of a film.

The first conductive agent of the complex 13 of the first conductive agent and the binding agent is a conductive material such as a graphite-based conductive material or a carbon-based conductive material. More particularly, the first conductive agent may be carbon nanotube (CNT), carbon nanohorn, carbon nanofiber (CNF), activated carbon fiber (ACF), ketjen black, denka black, acetylene black, and carbon black, but is not limited thereto.

The binding agent complex 13 of the first conductive agent and the binding agent may include a first group that binds to the surface of the active material, and a second group that binds mainly to the first conductive agent. Therefore, the bond between the first conductive agent and the binding agent and/or the bond between the active agent and the binding agent can be effectively obtained, resulting in high rate charge/discharge characteristics of the electrode.

The first group may be selected depending on the characteristics of the active material used. Non-limiting examples of the first group include a substituted or non-substituted C₁-C₂₀ alkoxy group, a substituted or non-substituted epoxy group, or a substituted or non-substituted oxetane group, but are not limited thereto.

More particularly, the first group may be a C₁-C₂₀ alkoxy group, a C₁-C₂₀ alkoxy group or epoxy group substituted with a C₁-C₂₀ alkoxy group, but is not limited thereto.

The second group may be selected depending on the first conductive agent used. Non-limiting examples of the second group include a group represented by —NZ₁Z₂, a substituted or non-substituted C₂-C₂₀ alkenyl group, a mercapto group, a substituted or non-substituted C₁-C₂₀ alkyl group, a substituted or non-substituted C₃-C₂₀ cycloalkyl group, a substituted or non-substituted C₅-C₂₀ aryl group, a nitro group, a cyano group, a sulfonyl group, a boronic acid group, a phosphoric acid group, a halogen atom, or a carboxyl group. Z₁ and Z₂ may independently be a hydrogen or a substituted or non-substituted C₁-C₂₀ alkyl group.

For example, the second group may be an amino group, a vinyl group, a mercapto group, a C₁-C₂₀ alkyl group, a C₁-C₆ alkyl group substituted by at least one halogen atom, a C₁-C₆ alkyl group substituted by an amino group, a C₁-C₆ alkyl group substituted by a mercapto group, a cyclohexyl group, a phenyl group, a naphthyl group, a pyrenyl group, an anthryl group, a perylenyl group, a triphenylenyl group, a nitro group, a cyano group, a sulfonyl group, a boronic acid group, a phosphoric acid group, a halogen atom, or a carboxyl group, but is not limited thereto.

The second group will mainly bind to the first conductive agent, but even if the active material according to aspects of the present invention is heat-treated under an oxidizing atmosphere, a small amount of carbon (for example, 0.5 wt % to 0.001 wt %) may remain on the surface of the active material, and thus a part of the second group may bind to the active material in some cases. Therefore, the description “second group that mainly binds to the first conductive agent” is used in order not to exclude a possibility that a part of the second group may bind to the surface of the active material, due to a small amount of carbon remaining on the surface of the active material as previously described.

More particularly, the binding agent may be represented by Formulas 1 or 2 below:

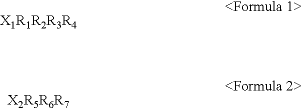

wherein X₁ may be Si or Ti, and X₂ may be Al.

In the formulae above, each of R₁ to R₇ may independently be a first group; a second group; a C₁-C₂₀ alkyl group; a C₁-C₂₀ alkyl group substituted by the first group or the second group; or a C₁-C₂₀ alkoxy group substituted by the first group or the second group. The first group and the second group are as previously defined.

As non-limiting examples, each of R₁ to R₇ above may independently be a C₁-C₂₀ alkyl group, a C₁-C₂₀ alkyl group substituted by a group represented by —NZ₁Z₂, a C₁-C₂₀ alkyl group substituted by a mercapto group, a C₁-C₂₀ alkoxy group, a C₁-C₂₀ alkoxy group substituted by a C₁-C₂₀ alkoxy group, or a C₂-C₂₀ alkenyl group. Here, Z₁ and Z₂ above may independently be hydrogen or a non-substituted C₁-C₂₀ alkyl group.

The C₁-C₂₀ alkyl group may be a linear chain or a branched structure, such as methyl, ethyl, n-propyl, isopropyl, n-butyl, isobutyl, sec-butyl, t-butyl, pentyl, iso-amyl, hexyl, and octadecyl. At least one of hydrogen atoms in the alkyl group may be selectively substituted by a hydroxyl group or a halogen atom such as fluorine, chlorine, or bromine.

The C₂-C₂₀ alkenyl group may be a linear chain or a branched structure, such as a vinyl group or a butenyl group. At least one of hydrogen atoms in the alkenyl group may be selectively substituted by a hydroxyl group or a halogen atom such as fluorine, chlorine, or bromine.

The C₁-C₂₀ alkoxy group may be represented by —OA, wherein A may be a C₁-C₂₀ alkyl group as previously described. Examples of the alkoxy group may include methoxy, ethoxy, propoxy, butoxy, and t-butoxy. At least one of hydrogen atoms in the alkoxy group may be selectively substituted by a hydroxyl group or a halogen atom such as fluorine, chlorine, or bromine.

The C₃-C₂₀ cycloalkyl group is an alkyl group with a ring structure, such as a cyclohexyl group. At least one of hydrogen atoms in the cyclohexyl group may be selectively substituted by a hydroxyl group or a halogen atom such as fluorine, chlorine, or bromine.

The term “C₅-C₂₀ aryl group” refers to an aromatic system containing at least one aromatic ring, wherein two or more aromatic rings in the system are connected by a single bond or fused. Examples of a C₅-C₂₀ aryl group include a phenyl group, a naphthyl group, an anthryl group, an azulenyl group, a fluorenyl group, a phenalenyl group, a phenanthrenyl group, a triphenylenyl group, a pyrenyl group, a chrysenyl group, a picenyl group, a perylenyl group, and a pentaphenyl group. Moreover, the aromatic system may be a system wherein 1 to 5 phenylene groups are connected by a single bond, with a phenyl group connected to the end of the system.

The binding agent according to Formulae 1 and 2 as previously described may effectively bond with the first conductive agent and/or the active material, and hence the complex 13 of the first conductive agent and the binding agent may exist mainly on the surface of the active material 11, as shown in FIG. 1. Thus, an electrode with improved high rate charge-discharge characteristics can be obtained.

According to specific examples, the binding agent may be aminopropyltriethoxy silane, vinyltriethoxy silane, vinyltris(2-methoxyethoxy) silane, N-octadecyltrimethoxy silane, or mercaptopropyl trimethoxy silane, but is not limited thereto.

A binder 17 and a second conductive agent 15 may be included in between particles of the active material 11 and/or between the active material 11 and the current collector (not shown in FIG. 1).

The binder 17 may be arbitrarily selected from the well-known binders available for preparing an active material layer. The second conductive agent 15 may be selected from among graphite-based conductive materials or carbon-based conductive materials, and may be the same as or different from the first conductive agent which makes up the complex 13 of the first conductive agent and the binding agent.

The total relative amount of conductive agents included in the active material layer may be less than 20 parts by weight based on 100 parts by weight of the active material layer. As more specific, non-limiting examples, the total relative amount of conductive agents included in the active material layer may be 0.001 to 20 parts by weight, or more specifically 1 to 10 parts by weight based on 100 parts by weight of the active material layer. The term “total relative amount of conductive agents”, refers to the relative amount of only the first conductive agent if the second conductive agent is not included in the active material layer, and refers to a sum of the contents of the first conductive agent and the second conductive agent if the second conductive agent is included in the active material layer. If the total relative amount of the conductive agents included in the active material layer is less than 20 parts by weight based on 100 parts by weight of the active material layer, a decrease of capacity per unit area due to relative increase of the conductive agent content can be prevented.

Meanwhile, the relative amount of the binding agent in the complex 13 of the first conductive agent and the binding agent may be less than 30 parts by weight, based on 100 parts by weight of the first conductive agent. As more specific, non-limiting examples, the relative amount of the binding agent may be 0.001-30 parts by weight, or more specifically 0.01-25 parts by weight based on 100 parts by weight of the first conductive agent. If the relative amount of the binding agent in the complex 13 of the first conductive agent and the binding agent is less than 0.001 parts by weight based on 100 parts by weight of the first conductive agent, a part of the first conductive agent in the complex 13 of the first conductive agent and the binding agent may be separated from the active material due to the addition of the binder, resulting in a decrease in the high rate characteristics, and if the relative amount is higher than or equal to 30 parts by weight, the relative amount of the binding agent becomes high, resulting in a decrease in the conductivity.

According to an embodiment of the present invention, a method of preparing the electrode as described above may include: preparing a first mixture including an active material, a first conductive agent, and a solvent; adding a binding agent to the first mixture to obtain a second mixture and stirring the second mixture; preparing a third mixture including a complex of the first conductive agent and the binding agent, wherein the complex of the first conductive agent and the binding agent exists on a surface of the active material, from the second mixture; preparing an active material layer forming composition by adding a binder to the third mixture; and forming an active material layer on top of a current collector using the active material layer forming composition.

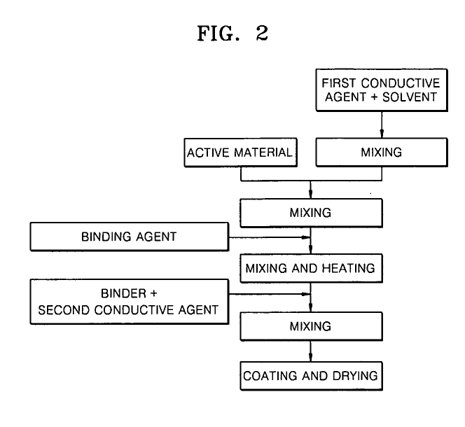

The method of preparing the electrode of the present invention is described in more detail with reference to FIG. 2. First, a first mixture including an active material, a first conductive agent, and a solvent is prepared. To obtain the first mixture, the first conductive agent and the solvent can be mixed first as shown in FIG. 2, and the active material can be mixed into the resultant composition. The active material and the first conductive agent are as previously described. The solvent may be selected from solvents that are conventionally used in active material forming compositions. Non-limiting examples include chain-type carbonates such as dimethyl carbonate, ethylmethyl carbonate, diethyl carbonate, and dipropyl carbonate, dimethoxyethane, diethoxyethane, fatty acid ester derivatives, cyclic carbonates such as ethylene carbonate, propylene carbonate, and butylene carbonate, gamma-butyl lactone, N-methylpyrrolidone, acetone, and water. A combination of two or more compounds may also be used.

Next, a binding agent is added to the first mixture and stirred to obtain a second mixture. The first conductive agent and the binding agent can bind or coalesce to the surface of the active material. The binding agent is as previously described.

The second mixture is then treated with, for example, heat, UV, or ultrasonication, to form a complex of the first conductive agent and the binding agent that binds to the surface of the active material. The resultant mixture including the complex of the first conductive agent and the binding agent binding to the surface of the active material is referred to as the third mixture.

By treating the second mixture with, heat, UV, or ultrasonication, the first complex of the first conductive agent and the binding agent cannot be substituted with a binder to be added in the following process, even when the binder is added later. Thereby, the first conductive agent can basically be present on the surface of the active material. Moreover, in the process of hybridizing the first conductive agent and the active material, adverse effects such as a collapse of the crystalline structure of the active material or an increase of the specific surface area is eliminated, thereby preventing the occurrence of a non-reversible reaction during a charging/discharging procedure due to a collapse of the active material crystalline structure or an increase of the specific surface area.

The active material layer forming composition is provided by adding a binder solution to the third mixture. A second conductive agent may further be added, as shown in FIG. 2.

The binder used for forming the active material layer may be arbitrarily selected from among publicly known binders. For example, a vinylidene fluoride/hexafluoropropylene copolymer, polyvinylidenefluoride, polyacrylonitrile, polymethylmethacrylate, polytetrafluoroethylene and mixtures thereof, or a styrene butadiene rubber-based polymer may be used, but is not limited thereto. The amount of the binder may be selected within the conventional range for active material layer formation.

The binding strength between the binding agent and the active material according to aspects of the present invention is larger than the binding strength between the binder and the active material. Therefore, the binding agent and the active material do not separate to any practical extent by addition of the binder as previously described.

Next, the electrode is completed by forming the active material layer on top of a current collector using the active material layer forming composition. Several approaches for forming the electrode are possible. For example, the active material layer forming composition may be coated directly on top of the current collector, or the active material layer forming composition may be cast on a separate supporting body, and then the active material layer film may be peeled off from the supporting body and laminated on top of the current collector.

The electrode as previously described can be used in secondary batteries, and particularly in lithium batteries. A lithium battery including such electrode as a cathode can be prepared according to the following:

First, a cathode active material is selected to prepare an electrode having a structure as previously described.

Next, an anode active material, a conducting agent, a binder, and a solvent are mixed to prepare the anode active material composition. An anode plate may be prepared by directly coating and drying the anode active material composition on the copper current collector. Alternatively, the anode active material composition may be cast onto a separate supporting body, and then the film may be peeled off from the supporting body and laminated on an aluminum current collector to produce the anode plate.

For the anode active material, well-known anode active materials may be used. For example, metal-based anode active material, carbon-based anode active material, or a combination anode active material thereof may be used. For the carbon-based anode active material, carbon, such as at least one material selected from the group consisting of graphite (e.g. natural graphite and artificial graphite), soft carbon, and hard carbon may be used, and for the metal-based anode active material, at least one metal selected from the group consisting of Si, Sn, Al, Ge, Pb, Zn, Ag, and Au, or alloys thereof, may be used. Complex anode active materials including the above can be produced by mixing the carbon-based anode active material and the metal-based active material, then treating the mixture physically by a method such as ball milling. Further processing, such as heat treating, can also be included, if desired. Non-limiting examples of the anode active material composition include a silicon/carbon compound or a tin/carbon compound. For the anode active material compositions, the conductive agent, the binder, and the solvent used may be the same as those of the cathode. The anode active material, the conductive agent, the binder, and the solvent may be used in the same amounts that are conventionally used in lithium batteries.

Also, a variety of modifications are possible, such as using an electrode made of a lithium metal as the anode plate.

If desired, a plasticizer may further be added to the cathode active material composition and the anode active material composition to form pores within the electrode plate.

For the separator, any separator that is conventionally used in lithium batteries can be used. Particularly, a separator with a low resistance with regards to ion transport of the electrolyte and a superior liquid-retention capacity for the electrolyte solution is desirable. For example, a material selected from glass fiber, polyester, TEFLON, polyethylene, polypropylene, polytetrafluoroethylene (PTFE), or combinations thereof may be used, in either woven or non-woven state.

The battery structure is formed by disposing the separator between the cathode plate and the anode plate. Such a battery structure is wound or folded and inserted into a tube-type battery case or an angular battery case, and then an organic electrolyte solution is injected in the battery structure to complete the lithium ion battery. Alternatively, the battery structure can be stacked into a bi-cell structure, immersed in an organic electrolyte solution, and the resulting product can be sealed in a pouch to obtain a lithium ion polymer battery.

The organic electrolyte solution includes lithium salt and a mixed organic electrolyte comprising a high permittivity solvent and a low boiling point solvent, and may further include a variety of additives such as an overcharge inhibitor if necessary.

The high permittivity solvent used for the organic electrolyte solution is not particularly limited and may be a high permittivity solvent conventionally used in the art. For example, cyclic carbonates such as ethylene carbonate (EC), propylene carbonate, butylene carbonate, or a gamma-butyrolactone can be used.

Moreover, the low boiling point solvent may be a low boiling point solvent conventionally used in the art, and may include chain-type carbonates such as dimethyl carbonate, ethylmethyl carbonate, diethyl carbonate (DEC), and dipropyl carbonate, dimethoxyethane, diethoxyethane, and fatty acid ester derivatives, but is not specifically limited thereto.

At least one hydrogen atom on the high permittivity solvent and the low boiling-point solvent may be substituted with a halogen atom, such as, for example, fluorine.

The mixing volume ratio of the high permittivity solvent and the low boiling-point solvent may be 1:1 to 1:9, which is a desirable range in terms of discharge capacity and charge/discharge lifespan.

Moreover, the lithium salt used for the organic electrolyte solution may be a lithium salt that is used conventionally in lithium batteries, such as, for example, a compound selected from the group consisting of LiClO₄, LiCF₃SO₂, LiPF₆, LiN(CF₃SO₂)₂, LiBF₄, LiC(CF₃SO₂)₃, and LiN(C₂F₅SO₂)₂.

In the organic electrolyte solution, the concentration of the lithium salt may be approximately 0.5 to 2 M, as a non-limiting example, If the concentration is below 0.5 M, the conductivity of the electrolyte may decrease, resulting in a decrease in the electrolyte performance, and if the concentration is higher than 2.0 M, the electrolyte viscosity may increase, resulting in a decrease in the lithium ion mobility.

Hereinafter, aspects of the present invention are described in more detail with respect to preferred examples, but the present invention is not limited thereto.

### EXAMPLES

### Comparative Preparation Example 1

0.2 g of CNT powder (product of Il-Jin Co.) as a conductive agent and 10 g of N-methylpyrrolidone as a solvent were mixed and stirred using a mechanical stirrer. 9.6 g of LiCoO₂ powder (mean particle size less than 20 μm) was added as a cathode active material core to the obtained mixture, and the resultant product was stirred using the mechanical stirrer. 2 g of PVDF 10 wt % (solvent: N-methylpyrrolidone) was added to the resultant product and the newly-obtained mixture was stirred using the mechanical stirrer to produce a slurry. The slurry was sprayed onto an Al current collector to a thickness of 200 μm using a doctor blade, dried, and dried again in a vacuum atmosphere at 130° C. to produce a cathode plate.

### Preparation Example 1

0.08 g of CNT powder (Il-Jin Co.) as a conductive agent (first conductive agent) and 10 g of N-methylpyrrolidone as a solvent were mixed and stirred using a mechanical stirrer. 9.6 g of LiCoO₂ powder (mean particle size less than 20 μm) was added as a cathode active material core to the obtained mixture, and the resultant product was stirred using the mechanical stirrer. 0.5 g of aminopropyltriethoxy silane was added as a binding agent to the resultant product (a first mixture) and stirred using the mechanical stirrer to obtain a second mixture. Then, the second mixture was stirred at 100° C., THAT is, heat-treated, to obtain a third mixture including a complex formed of the first conductive agent and the binding agent that binds to the surface of the active material. Then, 2 g of PVDF 10 wt % (solvent: N-methylpyrrolidone) and 0.12 g of the conductive agent (second conductive agent)(CNT powder, Il-Jin Co.) were added to the third mixture, which was then stirred using the mechanical stirrer to produce a slurry, which is an active material layer forming composition. The slurry was sprayed onto an Al current collector to a thickness of about 200 μm using a doctor blade, dried, and dried again in a vacuum atmosphere at 130° C. (when dried, the weight of aminopropyltriethoxy silane became 0.01 g) to produce a cathode plate.

### Comparative Preparation Example 2

A cathode plate was prepared using the same method as in the Preparation Example 1, except that 0.04 g of aluminum tri-isopropoxide was added instead of aminopropyltriethoxy silane (in this case, the weight of aluminum tri-isopropoxide became 0.01 g after drying).

### Comparative Preparation Example 3

A cathode plate was prepared using the same method as in the Preparation Example 1, except that 0.08 g of aluminum tri-isopropoxide was added instead of aminopropyltriethoxy silane.

### Preparation Example 2

A cathode plate was prepared using the same method as in the Preparation Example 1, except that the amount of aminopropyltriethoxy silane added was 1.0 g instead of 0.5 g.

### Preparation Example 3

A cathode plate was prepared using the same method as in the Preparation Example 2, except that vinyltriethoxy silane was used instead of aminopropyltriethoxy silane.

### Preparation Example 4

A cathode plate was prepared using the same method as in the Preparation Example 2, except that vinyltris(2-methoxyethoxy) silane was used instead of aminopropyltriethoxy silane.

### Preparation Example 5

A cathode plate was prepared using the same method as in the Preparation Example 2, except that N-octadecyltrimethoxy silane was used instead of aminopropyltriethoxy silane.

### Preparation Example 6

A cathode plate was prepared using the same method as in the Preparation Example 2, except that mercaptopropyl trimethoxy silane was used instead of aminopropyltriethoxy silane.

### Evaluation Example 1

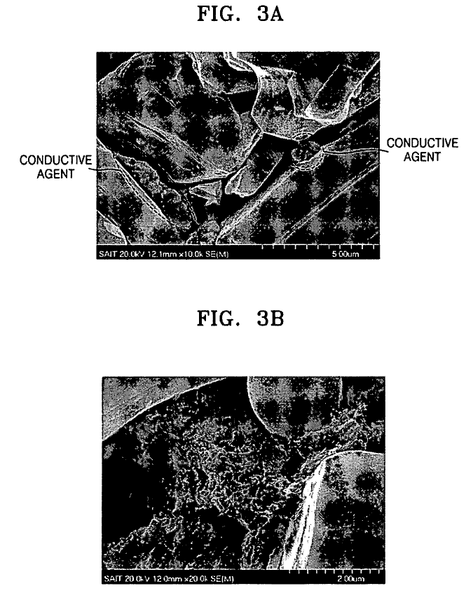

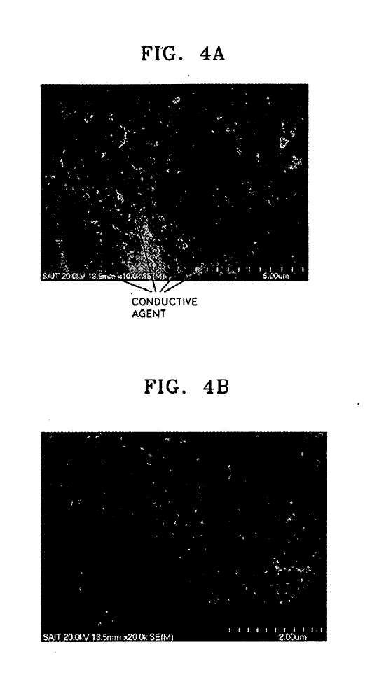

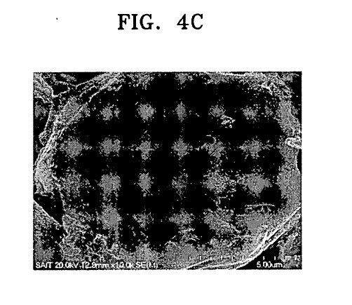

SEM images of the cathode plate obtained in Comparative Example 1 are shown in FIGS. 3A and 3B. Referring to FIGS. 3A and 3B, the conductive agent that coalesced on the surface of the active material can be identified. SEM images of the cathode plate obtained in Example 1 are shown in FIGS. 4A, 4B, and 4C. Referring to FIGS. 4A, 4B, and 4C, the conductive agent-binding agent complex that is distributed evenly on the surface of the active material can be identified.

### Comparative Example 1

A 2016 size coin cell was manufactured from the cathode plate produced in Comparative Preparation Example 1 by using lithium metal as a counter electrode, PTFE separator and a solution of 1.3 M LiPF₆ dissolved in a mixture (volume ratio 3:7) of EC (ethylene carbonate) and DEC (diethyl carbonate) as an electrolyte.

### Comparative Examples 2 and 3

Cells were prepared using the same method as in Comparative Example 1 above, except that cathode plates respectively obtained from Comparative Preparation Examples 2 and 3 were used instead of the cathode plate obtained from Comparative Preparation Example 1.

### Examples 1 Through 6

Cells were prepared using the same method as in Comparative Example 1 above, except that cathode plates respectively obtained from Preparation Examples 1 through 6 were used instead of the cathode plate obtained from Comparative Preparation Example 1.

### Evaluative Example 2

For each of the coin cells obtained from Comparative Examples 1 through 3 and Examples 1 through 6, a constant voltage charge was applied at a current of 140 mA per 1 g of the active material (LiCoO₂), until the voltage of the Li electrode reached 4.3 V. After the fully charged cell had undergone a 10 minute rest period, a constant voltage discharge was carried out at a current of 140 mA per 1 g of the active material (LiCoO₂) until the voltage reached 3 V. The 2 C high rate discharge efficiency (%) was calculated by dividing the 2 C discharge capacity by the 0.2 C discharge capacity, and the 0.2 C high rate discharge efficiency (%) was calculated by dividing the 5 C discharge capacity by the 5 C discharge capacity, as represented in Table 1:

TABLE 1

| | | | 5 C |
|---|---|---|---|
| | | | discharge |
| | | 2 C discharge | efficiency |
| | | efficiency | (5 C |
| | | (2 C discharge | discharge |
| | | capacity/ | capacity/ |
| | | 0.2 discharge | 0.2 discharge |
| | Binding Agents | capacity) | capacity) |
| Comparative | — | 92.4% | 80.3% |
| Example 1 | | | |
| Comparative | 0.04 g of aluminum tri-isopropoxide | 92.5% | 81.2% |
| Example 2 | | | |
| Comparative | 0.08 g of aluminum tri-isopropoxide | 92.1% | 80.5% |
| Example 3 | | | |
| Example 1 | 0.5 g of aminopropyltriethoxy silane | 96.0% | 91.4% |
| Example 2 | 1 g of aminopropyltriethoxy silane | 95.8% | 91.2% |
| Example 3 | 1.0 g of vinyltriethoxy silane | 94.7% | 87.2% |
| Example 4 | 1.0 g of vinyltris(2-methoxyethoxy) silane | 94.9% | 86.5% |
| Example 5 | 1.0 g of N-octadecyltrimethoxy silane | 94.5% | 88.3% |
| Example 6 | 1.0 g of mercaptopropyl trimethoxy silane | 95.1% | 87.0% |

In Table 1, it is shown that the electrodes of Examples 1 through 6 have a superior discharge efficiency compared to the electrodes of Comparative Examples 1 through 3.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electrode comprising a current collector and an active material layer on top of the current collector,
wherein the active material layer comprises an active material a binder, and a complex of a first conductive agent and a binding agent formed on a surface the active material.

2. The electrode of claim 1, wherein the first conductive agent is a graphite-based conductive agent or a carbon-based conductive agent.

3. The electrode of claim 1, wherein the binding agent comprises a first group that binds to the surface of the active material and a second group that binds to the first conductive agent.

4. The electrode of claim 3, wherein the first group is selected from the group consisting of a substituted or non-substituted C₁-C₂₀ alkoxy group, a substituted or non-substituted epoxy group, and a substituted or non-substituted oxetane group.

5. The electrode of claim 3, wherein the second group is selected from the group consisting of a group represented by —NZ₁Z₂, a substituted or non-substituted C₂-C₂₀ alkenyl group, a mercapto group, a substituted or non-substituted C₁-C₂₀ alkyl group, a substituted or non-substituted C₃-C₂₀ cycloalkyl group, a substituted or non-substituted C₅-C₂₀ aryl group, a nitro group, a cyano group, a sulfonyl group, a boronic acid group, a phosphoric acid group, a halogen atom, and a carboxyl group,
wherein Z₁ and Z₂ are independently selected from the group consisting of a hydrogen and a substituted or non-substituted C₁-C₂₀ alkyl group.

6. The electrode of claim 1, wherein the binding agent is represented by one selected from the group consisting of Formulas 1 and 2 below: 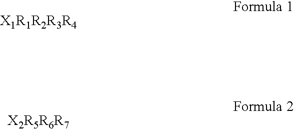
wherein X₁ is Si or Ti;
X₂ is Al; and
R₁ to R₇ are each independently one selected from the group consisting of:
a first group that binds to the surface of the active material;
a second group that binds mainly to the first conductive agent;
a C₁-C₂₀ alkyl group;
a C₁-C₂₀ alkyl group substituted by the first group or the second group; and
a C₁-C₂₀ alkoxy group substituted by the first group or the second group.

7. The electrode of claim 6, wherein the first group is selected from the group consisting of a substituted or non-substituted C₁-C₂₀ alkoxy group, a substituted or non-substituted epoxy group, and a substituted or non-substituted oxetane group and the second group is selected from the group consisting of a group represented by —NZ₁Z₂, a substituted or non-substituted C₂-C₂₀ alkenyl group, a mercapto group, a substituted or non-substituted C₁-C₂₀ alkyl group, a substituted or non-substituted C₃-C₂₀ cycloalkyl group, a substituted or non-substituted C₅-C₂₀ aryl group, a nitro group, a cyano group, a sulfonyl group, a boronic acid group, a phosphoric acid, a halogen atom, and a carboxyl group,
wherein Z₁ and Z₂ are independently selected from the group consisting of a hydrogen and a substituted or non-substituted C₁-C₂₀ alkyl group.

8. The electrode of claim 6, wherein R₁ to R₇ are each independently selected from the group consisting of a C₁-C₂₀ alkyl group, a C₁-C₂₀ alkyl group substituted by a group represented by —NZ₁Z₂, a C₁-C₂₀ alkyl group substituted by a mercapto group, a C₁-C₂₀ alkoxy group, a C₁-C₂₀ alkoxy group substituted by a C₁-C₂₀ alkoxy group, and a C₂-C₂₀ alkenyl group,
wherein Z₁ and Z₂ are independently selected from the group consisting of a hydrogen and a non-substituted C₁-C₂₀ alkyl group.

9. The electrode of claim 1, wherein the binding agent is selected from the group consisting of aminopropyltriethoxy silane, vinyltriethoxy silane, vinyltris(2-methoxyethoxy) silane, N-octadecyltrimethoxy silane and mercaptopropyl trimethoxy silane.

10. The electrode of claim 1, wherein the active material layer further comprises a second conductive agent.

11. The electrode of claim 1, wherein a total amount of the conductive agent comprised in the active material layer is 20 parts by weight, based on 100 parts by weight of the active material layer.

12. The electrode of claim 1, wherein a amount of the binding agent is less than 30 parts by weight, based on 100 parts by weight of the first conductive agent.

13. A method of preparing an electrode, comprising:
preparing a first mixture comprising an active material, a first conductive agent, and a solvent;
adding a binding agent to the first mixture to obtain a second mixture and stirring the second mixture;
preparing a third mixture in which the first conductive agent and the binding agent form a complex on a surface of the active material, from the second mixture;
preparing an active material layer forming composition by adding a binder to the third mixture; and
forming an active material layer on top of a current collector using the active material layer forming composition to form the electrode.

14. The method of claim 13, wherein the preparing of the third mixture is carried out by treating the second mixture with heat, UV, or ultrasonication.

15. The method of claim 13, wherein the preparing of the active material layer forming composition further comprises adding a second conductive agent in addition to the binder.

16. The method of claim 13, wherein in the preparing of an active material layer forming composition, a binding strength between the binding agent and the active material is greater than a binding strength between the active material and the binder.

17. A lithium battery comprising a cathode, an anode, and an electrolyte, wherein at least one of the cathode and the anode is the electrode according to claim 1.

18. An active material composition comprising
an active material in the form of particles having an average particle size of 1-20 μm and
a complex of a first conductive material and a binding agent, wherein the complex of the first conductive material and the binding agent binds to the active material.

19. The active material composition of claim 18, wherein the complex of the first conductive material and the binding agent completely covers the particles of the active material.

20. The active material composition of claim 18, wherein the complex of the first conductive material and the binding agent partially covers the particles of the active material.

21. The active material composition of claim 18, wherein the first conductive agent is a graphite-based conductive agent or a carbon-based conductive agent.

22. The active material composition of claim 18, wherein the binding agent comprises a first group that binds to the surface of the active material and a second group that binds to the first conductive agent.

23. The active material composition of claim 18, wherein the binding agent is selected from the group consisting of aminopropyltriethoxy silane, vinyltriethoxy silane, vinyltris(2-methoxyethoxy) silane, N-octadecyltrimethoxy silane and mercaptopropyl trimethoxy silane.

24. The active material composition of claim 18, further including a second conductive material and a binder between the particles of the active material.
